(19) United States
(12) Patent Application Publication
(10) Pub. No.: US 2013/0301673 A1
(43) Pub. Date: Nov. 14, 2013

(54) Method and Apparatus for Measuring, Storing and Retrieving Food Temperature Data

(71) Applicants: Jason Mobley, West Melbourne, FL (US); Alberto Arzola, Melbourne, FL (US)

(72) Inventors: Jason Mobley, West Melbourne, FL (US); Alberto Arzola, Melbourne, FL (US)

(21) Appl. No.: 13/887,503

(22) Filed: May 6, 2013

Related U.S. Application Data
(60) Provisional application No. 61/643,214, filed on May 4, 2012.

(51) Int. Cl. G01K 3/04

(52) U.S. Cl. CPC G01K 3/04
USPC 374/102

(57) ABSTRACT

A method for determining false temperature measurements using a food temperature measuring device. The method comprises: (a) measuring a first temperature of a first food item using a temperature probe; (b) commanding a second temperature measurement to be executed; (c) determining a time interval between executing the steps (a) and (b); and (d) indicating a false temperature measurement responsive to step (c).

### RELATED APPLICATIONS

The present application claims the benefit under Section 119(e) of the provisional patent application filed on May 4, 2012 and assigned application No. 61/643214, which is incorporated by reference in its entirety in the present application.

### FIELD OF THE INVENTION

The present invention relates to generally to a device for measuring, storing and retrieving food temperature data, and more specifically to such a device for collecting food temperature data, storing and retrieving that data as desired, further including operational checklists and subsystems for use in operating the device.

### BACKGROUND OF THE INVENTION

Generally, the food service industry follows the Hazard Analysis and Critical Control Points (HACCP), which is a systematic preventive approach to food safety and has been incorporated in legislation in the United States and other countries. More specifically, acceptable temperature ranges for food storage and food preparation have been incorporated in laws, codes, regulations etc. at both the national and local levels.

In addition, privately-owned companies that operate food service facilities may adopt food safety standards that are more stringent than those standards adopted by government entities or agencies. Food service facilities, such as restaurants, cafeterias and the like, are customarily required to measure the actual temperature of the food items within food storage areas and to maintain a record of these measurements for review by third parties (e.g., representatives of a parent/owner company and health department personnel). In addition, the temperature of food preparation equipment and food storage areas, such as walk-in coolers, freezers, food holding units and the like, are monitored and recorded.

Taking the case of a delicatessen as a non-limiting example, a food safety temperature recording log, in the form of a prior art handwritten spreadsheet includes a list of food items and food storage equipment, and is used to record and log temperatures of food items and the equipment. The temperature of food items or equipment is measured (usually at least twice a day) typically using a pocket stem thermometer or hand-held digital thermometer. The measurements are manually recorded by an individual taking the measurements. Recording the measurements builds a paper trail that allows health department or supervisory personnel to determine whether a problem exists, which may constitute a potential health risk to facility patrons.

A practical problem with measuring and manually recording temperatures in this manner is that it is cumbersome, subject to human error and depends upon the faithfulness of the individual charged with the duty of taking the measurements, despite more immediate tasks that must be addressed. Indeed, it is sometimes the case that temperature records are created without actually conducting the temperature measurement or the temperature measurement requirement is ignored. Moreover, if the measurements indicate that a food item or equipment temperature is not within an acceptable range and thereby requires remedial attention, such information is typically not immediately available to personnel. Not having information regarding required remedial actions and the availability of equipment to implement those actions may result in a delay in undertaking corrective action or the lack of undertaking any corrective action at all.

In addition to the above-referenced manual recordation of food and equipment temperatures, corrective actions relative to food items or food storage equipment are manually recorded on an action log spreadsheet providing a date and time of temperature measurements and a description of a corrective action taken. An individual who supervises a plurality of food service facilities, such as a district manager of several franchise restaurants, may not know of food temperature issues, the need for correction action or the outcome of the corrective action unless he receives timely and complete food temperature reports.

Accordingly, a need exists in food service facilities for an automated system that collects and records temperature data relative to food items and food storage equipment, and also provides an automated instruction of a correction action to be taken in the event the temperature of a food item or equipment does not fall within a predetermined temperature range. In addition, a need exists for a system that provides for the automated recording of corrective actions taken to bring temperatures of food items or equipment into compliance with predetermined food storage standards.

### BRIEF DESCRIPTION OF THE FIGURES

The present invention can be more easily understood and the advantages and uses thereof more readily apparent when the following detailed description of the present invention is read in conjunction with the figures wherein:

FIG. 1 is a block diagram of a food temperature measurement device of the present invention.

FIG. 2 is a display screen of the device of FIG. 1.

FIGS. 3-7 display various display screens and navigation between display screens associated with the present invention.

FIG. 8-10 are additional display screens of the present invention.

FIGS. 11 and 12 illustrate a probe sanitizing sheath of the present invention.

FIG. 13 is a flow chart depicting a false temperature measurement algorithm.

### DESCRIPTION OF THE INVENTION

Before describing in detail the particular method and apparatus for determining, storing and retrieving food temperature data, it should be observed that the present invention resides primarily in a novel and non-obvious combination of elements and process steps. So as not to obscure the disclosure with details that will be readily apparent to those skilled in the art, certain conventional elements and steps have been presented with lesser detail, while the drawings and the specification describe in greater detail other elements and steps pertinent to understanding the invention.

The following embodiments are not intended to define limits as to the structure or method of the invention, but only to provide exemplary constructions. The embodiments are permissive rather than mandatory and illustrative rather than exhaustive.

The present invention comprises a food temperature collection, storage and retrieval system, operational checklists and subsystems thereof. More specifically, embodiments of the invention are directed to the use of a hand-held food and/or equipment temperature collection, storage and retrieval system, comprising an internal programmed processor or programmed microcontroller and a memory element to control and expedite measuring and recording temperatures of a plurality of food items and food storage or cooking equipment in a food service facility, such as a restaurant. The food temperature and checklist data can later be retrieved to create a temperature log of food items, storage areas and cooking equipment to facilitate compliance with health and food safety codes, regulations and standards.

An embodiment of the invention for an automated system for collecting, storing and retrieving temperature and operational checklist data relative to food items and food storage equipment comprises a hand-held display and data input unit coupled to a temperature probe. The system comprises, in the hand-held unit, a memory element for storing one or more predetermined temperature ranges for each one of a plurality of food items or food storage equipment items. The memory element also maintains a log of measured temperature data for food items and/or food storage equipment, including the date and time when each temperature was measured. The system also comprises a processor that assigns a log number to each temperature measurement and the memory element stores the log number with the date, time and measured temperature associated with the food item or food storage equipment.

The hand-held unit may also display user-selectable options responsive to an out-of-range food item or equipment temperature, which options may include re-measuring the temperature of the food item or food storage equipment, initiating a corrective action process and, in the case of a food item, disposing of the food item. In the event that the re-measurement option is selected, the processor assigns the same log number to the re-measured temperature with a corresponding date and time. The first temperature measurement is associated with the re-measured temperature measurement of the food item or food storage equipment.

The processor, responsive to a command, may also initiate a corrective action process responsive to an out-of-range temperature measurement. The corrective action may include instructions for restoring the temperature of the food item or food storage equipment to the predetermined temperature range. After the corrective action has been taken a third temperature measurement may be taken and assigned the same log number as the first and the second temperature measurements, with a corresponding date and time. Alternatively, if the option for disposal of food is selected, the same log number is maintained for this action.

In this manner, the temperature measurement data may be reviewed to determine that appropriate steps were taken to correct the out-of-range temperature measurement. To that end, in one embodiment of the invention the memory element can interface with a computer to download the food item and food storage equipment temperature measurements. The computer is programmed to generate a temperature log report, preferably in a spreadsheet format. Data within the spreadsheet can be sorted according to different data fields such as a date, a specific food item or food storage equipment, a log number, or the temperature measurement. Accordingly, when an out-of-range temperature is detected, a user may access the temperature log report, identify an out-range-temperature measurement and sort the data according to the assigned log number to determine whether if anything was done to address the out-of-range temperature measurement.

In addition, the system may also include an Internet-based website for loading and accessing temperature measurement logs and the corrective action logs by personnel remotely located with respect to the food items and the food storage equipment.

According to another embodiment, the system also remotely connects to wireless temperature sensors that had been installed into other pieces of equipment throughout the foodservice establishment, such as a walk in cooler, a reach-in cooler or a freezer. This feature allows the system to report temperatures to a site remote from this equipment.

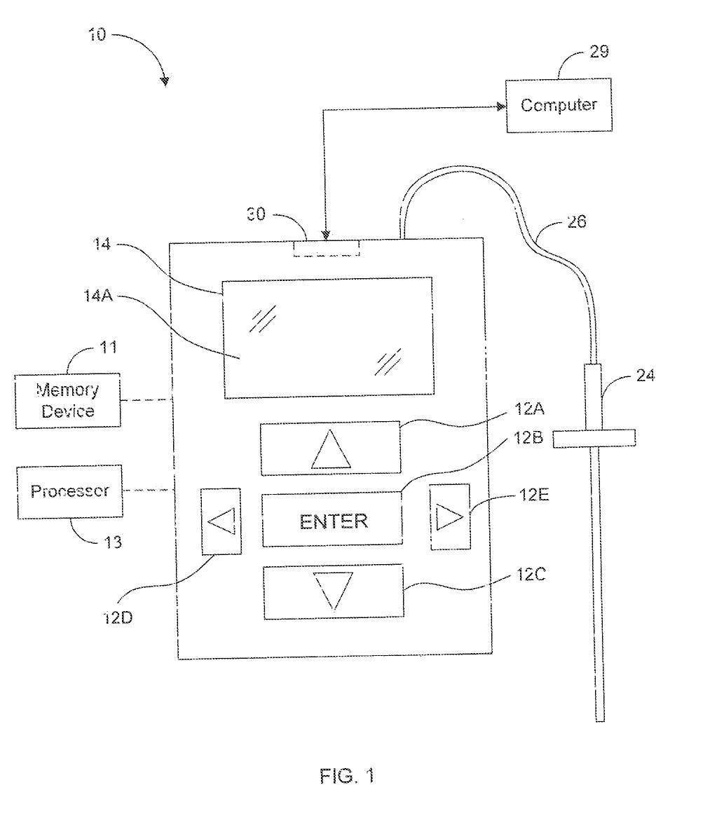

In accordance with one embodiment of the present invention, rather than rely on food service personnel to manually record temperature measurements and maintain a paper log compilation of such measurements, the individual charged with the task of making the measurements operates a hand-held temperature collection, storage and retrieval device (a data logging device) one embodiment of which is assigned reference numeral 10 in FIG. 1.

The device 10, comprising an ascending scrolling key 12A, an enter key 12B, a descending scrolling key 12C, a left key 12D, and a right key 12E and a display 14, is coupled to a temperature probe 24 via a conductor 26, a USB link, a wireless link or an optical link. The device 10 is further connected to a computer or data processing device 29 via a connector 30 (such as, through a suitable interface, a USB port, an Ethernet link, a WiFi link, a Bluetooth link, a serial port link or another wireless link) for downloading data from the computer 29 to the to the device 10 and for uploading data and control signals from the device 10 to the computer 29. Once the computer 29 is recognized as connected to the device 10 through the connector 30, the display 14 displays a suitable message and control is shifted to the computer 29 for configuring the device 10 and uploading data from and downloading data to the device 10.

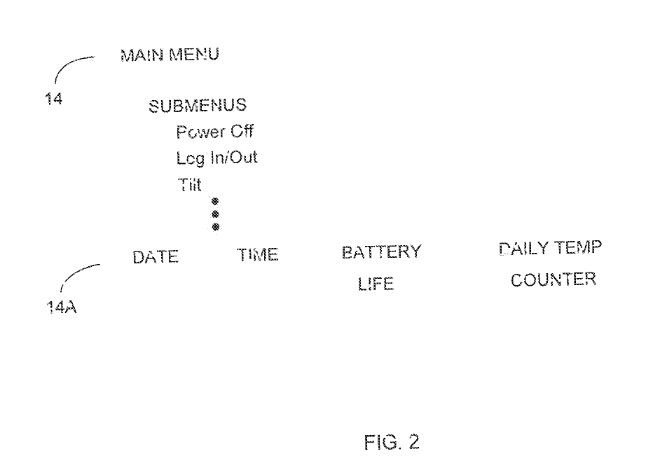

The user manipulates and selects text items or commands presented in the display 14 by operation of the scrolling keys 12A, 12C, 12D, 12E, and the enter key 12B. Responsive thereto the user is guided through the various processes, routines, checklists, and prompts presented on the display 14. Pressing the up scrolling key 12A from any screen returns the user to the screen of FIG. 2.

As further described below, the device 10 has a memory element 11 and a processor 13 to automatically record each temperature measurement according to the date, time of day, location of the food item (such as the sandwich unit, reach-in cooler, walk-in cooler, hot hold, cold hold and freezer units) of the food service facility. The device 10 also records temperature measurements of food items and food storage equipment (such as the sandwich unit, reach-in cooler, walk-in cooler and freezer units) including the date and time of the measurement. In addition, as explained in more detail elsewhere herein, a log number is assigned to each recorded food and food equipment temperature measurement.

As illustrated in FIG. 2, in one embodiment the month, day, year, and time are also presented on the display region 14A. These elements may be displayed when temperature measurements and/or corrective action information is presented on the display 14. Icons/text are also displayed in the region 14A that indicate a battery charge status and a daily temperature counter that tracks the number of temperature measurements stored in the device 10.

The display 14 may also provide a visual indication of the amount of memory used to store the temperature and corrective action information. This allows the user to determine when to transfer the data to the computer or data processing device 29 and thereby free memory within the memory unit 11.

FIG. 2 also illustrates a main menu presented on the display 14 from which the user selects one of several sub-menus, e.g., power off, log In/log out, TILT (time in lieu of temperatures), corrective sessions, take-temps, spot-check temps, timers, clock, settings, view temp data and information and statistics. In this case the user has selected the take-temps sub-menu and a block associated with the take-temps sub-menu is filled.

The device 10 may also have a sleep mode, which is activated in one embodiment after a user-programmable period of inactivity. When the device 10 has entered the sleep mode, a user may press any of the keys 12A-12E to terminate the sleep mode and activate the device 10 and the display 14. Whenever the device 10 wakes from the sleep mode the display 14 is in the previously operative mode (i.e. the active mode prior to onset of the sleep mode) with the previous user logged-in as the current user. In the illustrated sequence, it is assumed that the device awakes to the Main Menu screen.

Generally, the user can log into the system with a four digit security pin to allow use.

A description of the different modes of operation is now provided. Again with reference to FIGS. 2-7, there are illustrated screen displays, flow charts and processing blocks that represent and refer to the menus and sub-menus shown on the display 14. Alternatively, the blocks may be characterized as steps performed during operation of the device 10. Note that the invention is not limited to the described operational modes, food items or food storage equipment; the device can be customized to include different mode names, food items or food storage equipment as determined by the food served and the equipment employed at a particular food service operation. In addition, the terms “food storage equipment” and “food storage location” are used herein interchangeably and refer to the same items.

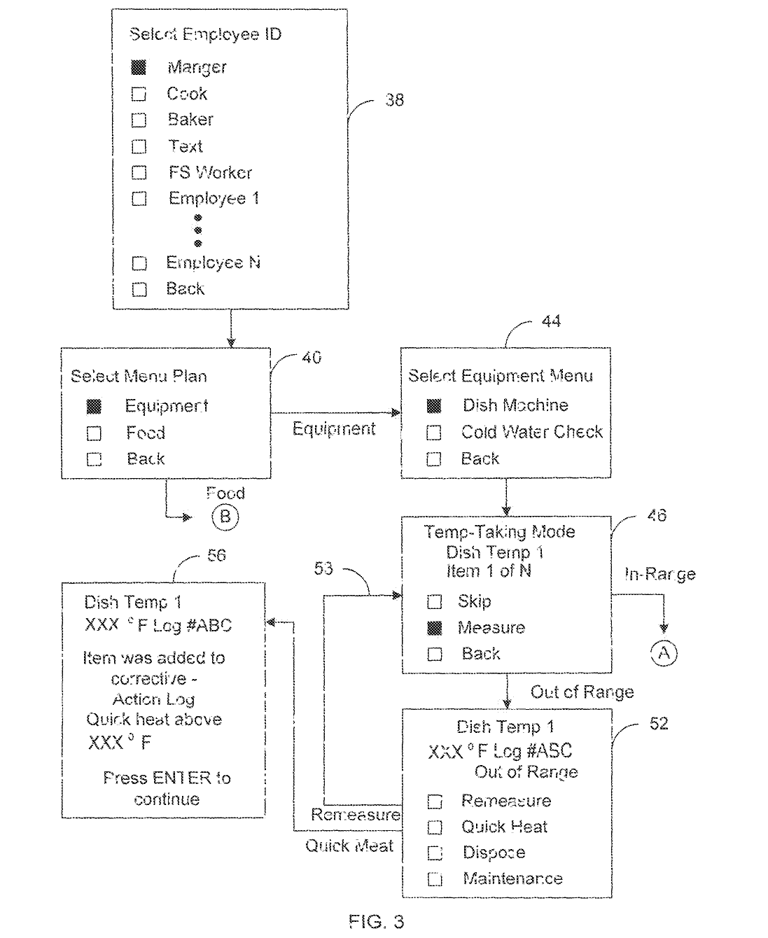

After the user selects the take-temps mode, names and/or positions of all authorized users are displayed on the display 14 (as shown in a menu screen 38 of FIG. 3. The user then scrolls through the temperature program list.

The device 10, through prompts shown on the display 14, guides the user through a programmed routine during which the user determines the temperature of identified food storage equipment. Different food storage items of equipment may be presented to different users. That is, every user may not be responsible for measuring the temperature of the same items of food storage equipment. Each food storage equipment measurement is declared either in-range or out-of-range and a corrective action plan, as described below, is set forth for the latter case.

With specific reference to FIG. 3, the equipment mode is selected from the menu 40 and the user is presented with an equipment menu 44 from which a specific item of equipment is selected. In the illustrated example, only the dish machine and the cold water supply are presented. The user can, through the settings sub-menu or the computer 20, add other or delete equipment items from the equipment menu 44.

A menu 46 prompts the user to skip or measure the temperature of the selected item of equipment and the device 10 reports the results of the temperature measurement on a display screen 52 as illustrated.

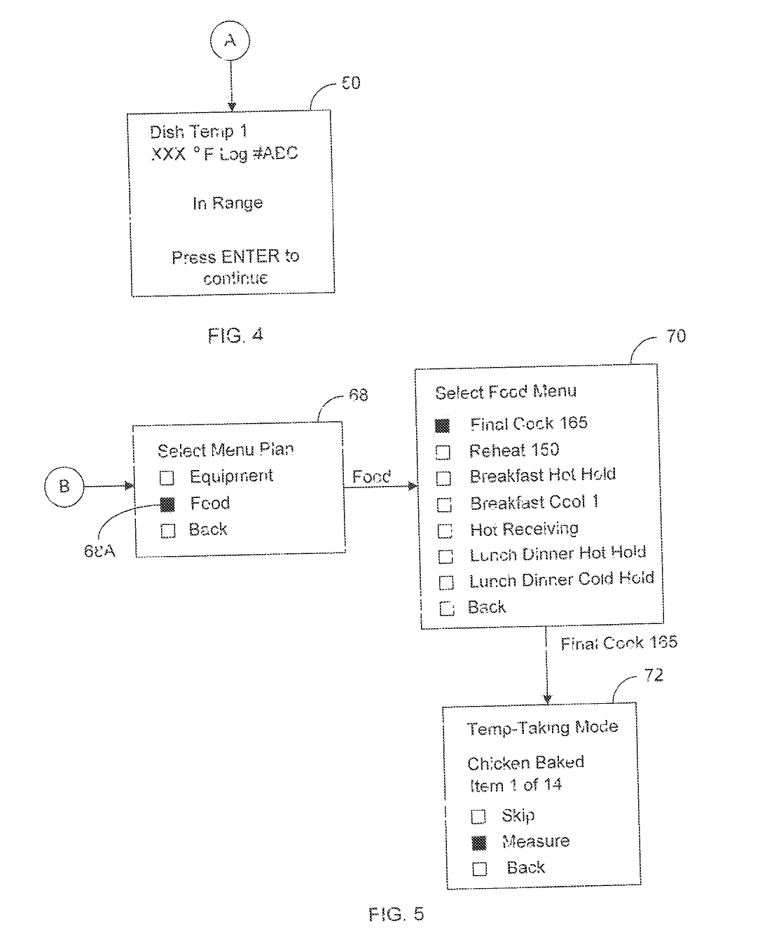

If the user selects the “measure” prompt the user places the probe 24 within or atop the food storage equipment and the device 10 measures the temperature. If the equipment temperature is within a predetermined range, an “In Range” text is rendered on the display 14 and the user is prompted to return to continue measuring another equipment item, as illustrated in a display screen 50 of FIG. 4.

If the measured temperature is out of range, the device 10 displays a screen 52 (see FIG. 3) that provides options from which the user selects. The temperature can be re-measured using the same procedure as set forth above. If the equipment temperature is again indicated as out-of-range, the food stored at the out-of-range temperature can be quick chilled or quick heated, as the case may be. Food stored at the out-of-range temperature can be disposed of and/or maintenance of the equipment can be initiated.

If the re-measure text item is selected, the device 10 loops back to the measure prompt as indicated by a process path 53.

If the quick heat/chill text item is selected, the device 10 opens a corrective action log and assigns a log number for the quick heat/chill operation for the specified food item that was affected by the out of range equipment. The display screen also indicates a temperature range. The food item temperature must be returned to this range within a predetermined number of minutes, which may depend on the specific food item and the difference between the desired temperature and the actual temperature. See display screen 56 of FIG. 3. Whenever the action item log is later entered, the device 10 displays the amount of time remaining for the quick chill/quick heat operation. The device 10 also advises when the corrective action has been completed by an appropriate message on the display screen 14.

If the dispose option is selected from the display screen 52, the food item, as maintained on a food item list within the device 10, is marked as discarded and the device 10 prompts the user to discard the food item.

If the maintenance option is selected from the display screen 52, maintenance personnel are contacted to repair the problem equipment item. This information is also entered on the corrective action log.

It is now assumed that the user selects the food sub-menu as illustrated by the filled-in block 68A in display screen 68 of FIG. 5. A display screen 70 displays food items according to one of the following entries: a food item name and a proper cooking or storage temperature; a meal during which the food item is served and a storage temperature; a meal during which the food item is served and a location where the food item is stored. Display screen 70 of FIG. 5 illustrates several examples. The user can add or delete food items and/or meals to the display screen 70 to customize the screen to a specific food service facility.

Upon selecting an item from the temperature program, the device 10 presents the user with a specific food item within the selected category, as illustrated by a display screen 72, which is presented when the user selects the final cook 165 item from the display screen 70.

Beginning at this point the process steps and screen displays related to measuring a food temperature are similar to the process steps and the screen displays illustrated in FIGS. 3 and 4 for measuring equipment temperature. The process begins with the screen display 52 (for an out-of-range temperature) or the display screen 50 (for an in-range temperature). To measure the food temperature, the user inserts the probe 24 into the food item and the temperature is displayed on the display screen 14. The temperature measurement is assigned a log number. A log entry for each food item includes the log number, the measured temperature, and the date and time of day when the measurement was taken,

Food items and food categories can be added or deleted from the device 10, and thus from the display screens 70 and 72, as needed by accessing the settings sub-menu or using the computer 29.

With reference to the display screen 72, one embodiment of the invention includes a reference (“Item 1 of 14”) to the number of identical food items (“Chicken Baked”) for which the temperature must be measured.

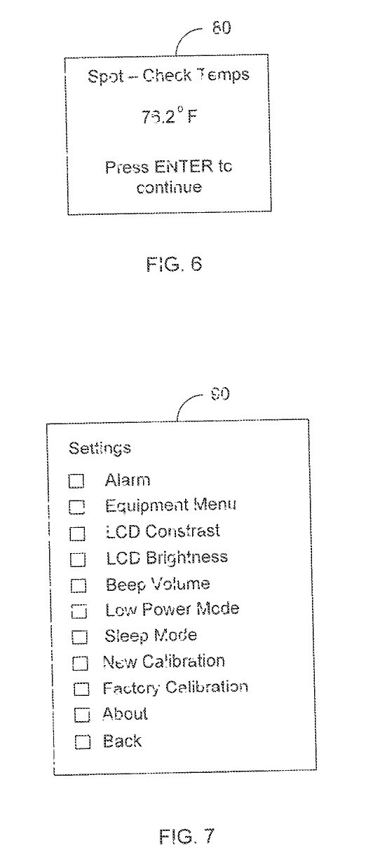

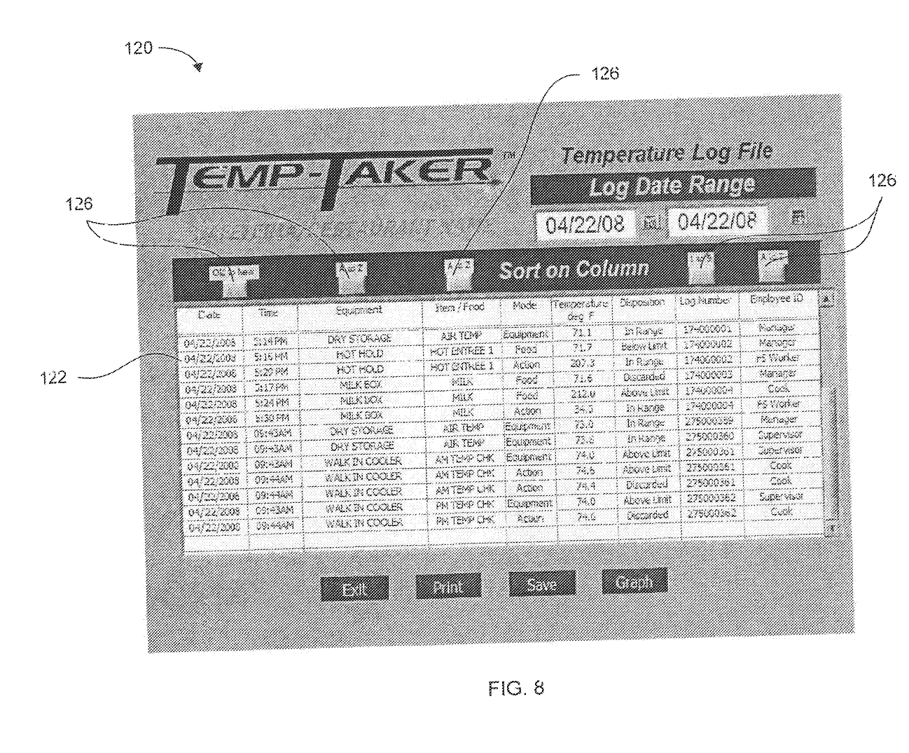

Returning to the display screen 14 of FIG. 2, if the user selects the spot-check temps item, the probe 24 is used to check the temperature of a food item or of a food equipment item. A display 80 of FIG. 6 reports the temperature of the item measured. The user depresses the enter key 12B to exit the spot-check temps mode. One embodiment includes a user option to retain a record of the temperatures measured in the spot-check temps mode. Another embodiment alerts the user when an out-of-temperature measurement is encountered.

Returning to the display screen 14 of FIG. 2, if the user selects the Settings item a display screen 90 as illustrated in FIG. 7 is presented.

Selecting the alarm submenu allows the user to arm or disarm a corrective action alarm by pressing the scroll up and down keys 12A and 12C. Various alarms can be activated or cancelled, including: when the user is required to take corrective action, when the user is to take temperature readings and when a corrective action (e.g., quick heat or quick cool) has ended.

The LCD contrast and brightness submenus, upon activation, allow the user to increase/decrease the contrast or brightness by manipulating the up and down arrow keys 12A and 12C. The beep volume can be similarly controlled, allowing the user to select discrete beep volumes or to turn the beep sound off.

Selection of the low power mode allows the user to select the number of seconds before the device 10 enters a low power state after a last key activation. In this mode the back light of the LCD screen is extinguished.

Selection of the sleep mode allows the user to select a number of seconds before the device 10 enters a sleep state. In the sleep state the device is completely powered-down.

In the calibration mode, the user calibrates the probe 24 by first immersing the probe 24 in an ice water bath (i.e., at 32° F.) and following the on-screen prompts. The probe is automatically calibrated and the user advised when the calibration is complete.

The user can also calibrate at 212° F. by immersing the probe 24 in a container of boiling water and again following the onscreen prompts.

The factory calibration mode returns the device 10 to the factory calibration settings by restoring the software temperature settings that were in place when the device 10 was manufactured.

Selection of the about submenu displays the manufacturer of the device 10, the device version and serial number and the manufacturer's website address.

FIG. 8 illustrates a temperature log file as generated and displayed by the computer 29, showing pertinent information, as set forth in each column heading, for each temperature measurement. In this format the temperature measurements are listed chronologically.

In accordance with an embodiment of the invention the device 10 uploads (on a programmable schedule) the collected temperature information, corrective action log information and associated parameters to the computer or data processing device 29. In one embodiment the computer or processing device 29 comprises a local computer, processor, server or other remote device. The uploaded information comprises the measured temperatures for the food items and the equipment, measurement date and time, user who took the measurements, disposition, and log number.

When resident in the computer 29, the data can be archived, analyzed, parsed, searched, graphed, printed, etc. or collected in a file and emailed to a third party. The ability to provide a print-out of the archival data is particularly useful if a complaint has been made by a facility customer (for example, a customer complaint that the consumed food made him/her ill). Accessing and analyzing the stored information, especially historical information, allows the food facility operator to assess the merits of such complaint.

By way of example a temperature log 120 is illustrated in FIG. 8. In this example, the data entries are sorted in the chronological order in which temperature measurement were taken on the given date of Apr. 22, 2008. The second listed entry 122 is a temperature measurement for a hot entrée 1 food item and assigned group number 174000002. The measured temperature is below a limit of a predetermined temperature range for the hot hold storage area. The temperature was measured at 5:16 PM and subsequent temperature measurements of other food items or food storage equipment were taken and determined to be in range, above limit, below limit, discarded, etc. A temperature of the food item represented by group number 17400002 was again measured at 5:29 PM. Note, a user knows this is the same food item because the temperature measurement is assigned the same log number. In addition, the user knows that appropriate corrective action was taken because the second temperature is in range and was taken at a time (13 minutes later) within the predetermined time period of 120 minutes to complete the corrective action.

The data in the temperature data log 120 may be sorted according to different data fields. In the illustrated example, each column with a sort icon at a head of the column may be used to sort all of the data present in the temperature data log 120. As shown, certain of the columns are sorted alphabetically, others chronologically, and still others numerically. For example, the tabular data may be sorted according to log number by clicking the icon at the head of the log number column.

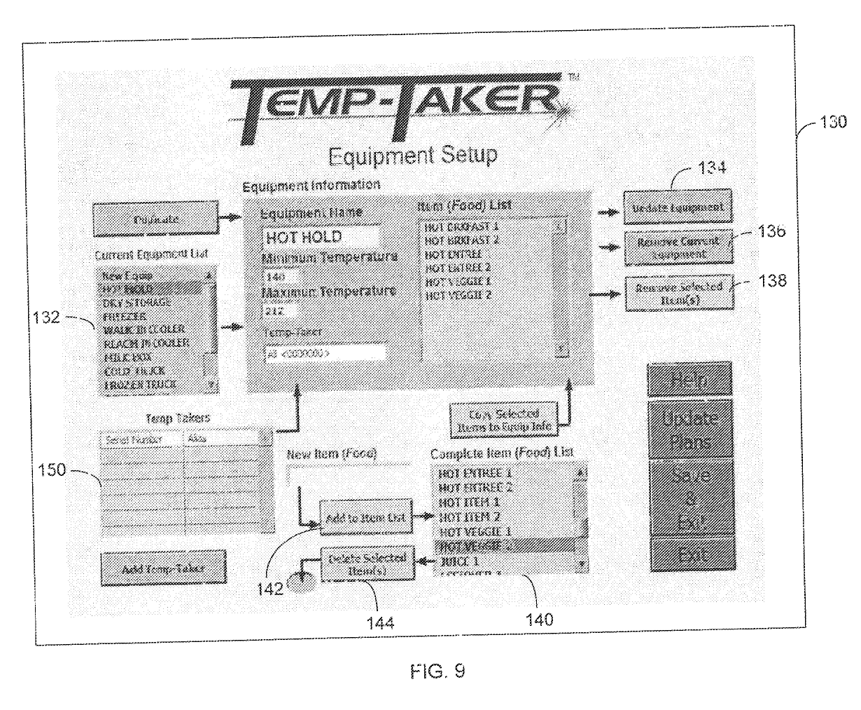

In FIG. 9 there is shown an equipment list 132 including for example hot hold, dry storage, freezer, walk in cooler, cold truck, etc., all of which are different food storage areas in which food items are stored. Note that the names of the particular food storage equipment or locations are not limited to those shown. The software application can customize the device to include any names of food storage locations.

The commands 134, 136 and 138 allow a user to update the equipment list, remove a displayed list item or remove a selected item. Similarly, there is shown a food item list 140 that includes cold entrée 1, cold entrée 2, cooking temperature 1, etc. Commands 142 and 144 allow the user to add or delete food items respectively. In addition the data fields 146 and 148 are for entry of the minimum and maximum temperatures. Note that the names of the particular food items are not limited those shown listed above. The software application can customize the device to include any names of food items.

The software application may also include a serial number data field 150 that allows a user to enter the serial number of the device 10. A food service facility may utilize a plurality of the devices 10 and each device may be programmed to include different food items or food storage equipment. For example, one device may be used solely to measure temperatures for food items, another device may be used solely to measure the temperatures of the food storage equipment or each device may be used to measure temperatures of food items in a specific food storage location.

The serial number and alias of personnel responsible for taking the storage and food temperatures can also be entered on the display screen 130 of FIG. 9.

As explained in more detail elsewhere, when temperature measurements are uploaded from the device 10 to the computer 29, the software executing on the computer is programmed to create a temperature log spreadsheet on command. The software is arranged so that each food item is associated with a particular food storage equipment item. For example, cold item 1 may be stored in the cold truck. The food items list may also include such items as AM Temp check and PM Temp check. Each of these items is not actually a food item but identifies an air temperature check within a particular piece of food storage equipment, such as a freezer.

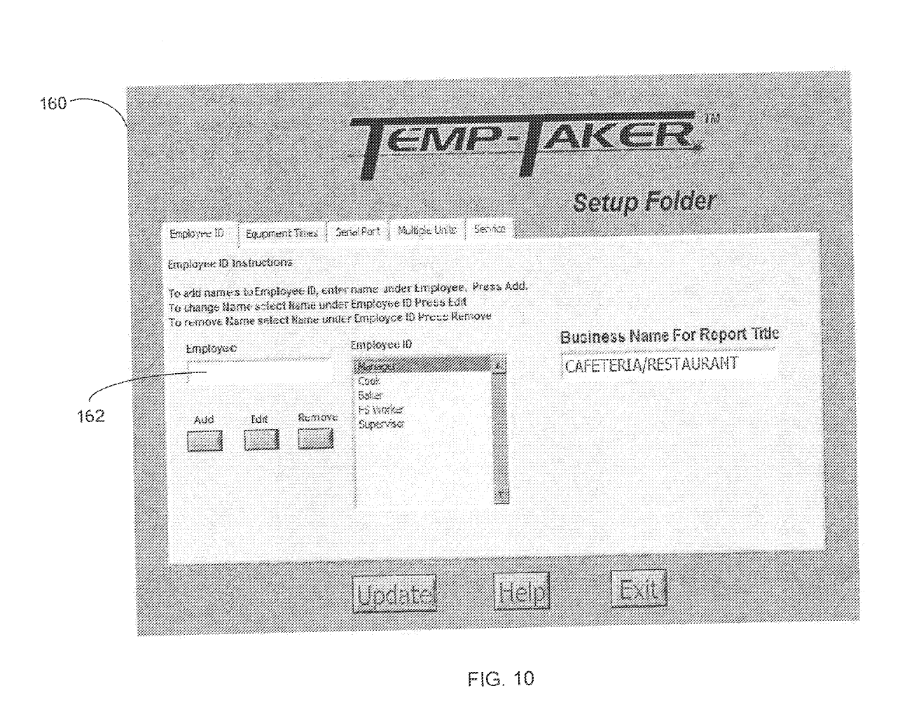

FIG. 10 illustrates a display screen 160; the selected tab allows the user to add/remove/edit names of personnel responsible for taking temperatures in a box 162. The employee identification can also be selected from a menu 164.

As can be surmised, the remaining tabs of the display screen 160 allow setting of the times for taking a temperature of the equipment and/or food items, configuring the serial port, managing multiple temperature measuring units, and service-related items.

In one operational mode routines and/or data as described below may be downloaded to the device 10 from the computer 29. In addition, temperature measurements and related data may be downloaded from the device to the computer 29, which has software that manipulates the data for review and analysis. An operator executes a software application running on the computer or processing device 29 to prepare the routines to be performed with the device 10. The software application prompts the operator for the location of the food service facility where the device 10 will be operated; the food items used there, the food storage facilities at the location, the names of authorized users at the facility and the permissible temperature range for each of the food items and the food storage equipment.

Responsive to the prompts, the operator enters the requested information or selects items from presented menus responsive to the prompts. Corrective action processes for food products that are beyond a desired temperature range are also entered by the operator. Alternatively, such corrective actions are programmed into the software application. In either case, the corrective actions are associated with food items and out-of-range temperature measurements for later use during operation of the device 10.

Other user-controllable operational features of the device 10 can be programmed by the computer or processing device 29. For example, the control routine includes a programmable calendar that alters certain functional operations of the device 10 on a daily basis according to calendar entries. The system can be programmed by indicating the food items that are to be checked for each day of the month. For example, a cafeteria user programs the food products that are to be checked each day of the month based on the day's menu.

When the user has completed executing through the software application, the device control routines are prepared and uploaded to the device 10 for control thereof during operation. The device 10 can later be returned to this operational mode, connected to the computer or processing device 29 to effect further changes or modifications to the device's control routines.

When corrective action is required for an out-of-range temperature, the device 10 generates a corrective action log. Data relative to a food item, food storage equipment, log numbers and temperature measurements for the same are stored in the action log of the memory element. This data includes one or more measured temperatures to determine if the corrective action taken has brought the temperature of the food item and/or food storage equipment within the predetermined temperature range. The user is also requested to perform a temperature remeasurement at this time.

In one embodiment, an action item log depicts one or more actions undertaken, the assigned log number, the food item, the time of the temperature measurement and the elapsed time within which a corrective action must be taken. If the corrective action is not taken within the time allowed the device 10 activates an alarm to remind the user to take the corrective action. In addition, one or more alarms may sound during the predetermined time period within which the corrective action must be taken to remind the user to undertake the corrective action.

In one embodiment, performing a re-save to the action item log resets the corrective action memory. Also according to one embodiment, the time remaining in the corrective action period is displayed in one or both of the time remaining in the corrective action period or the clock time when the corrective action period ends.

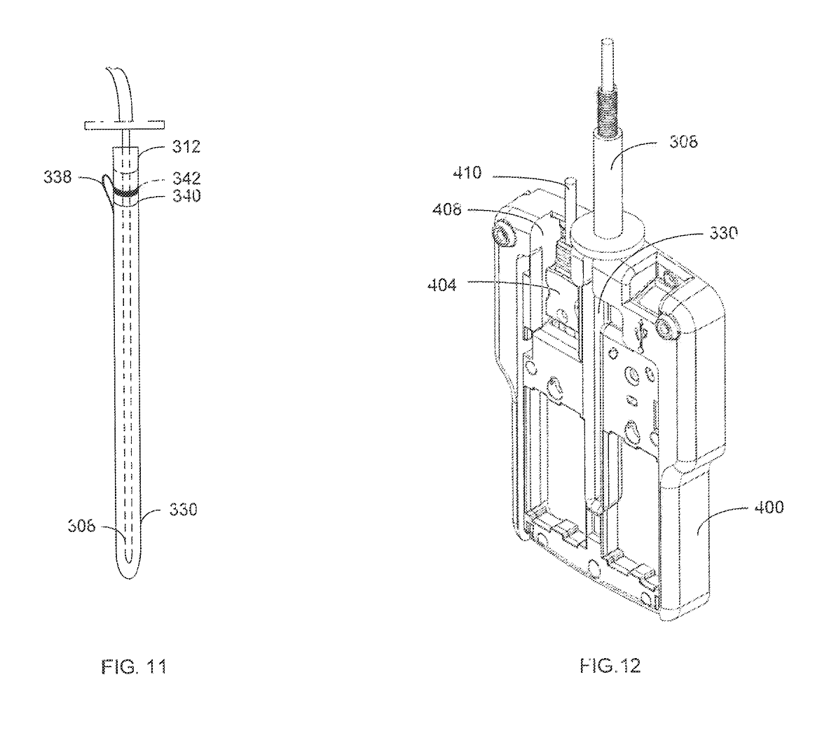

According to another embodiment, a device comprises a probe storage compartment illustrated in FIGS. 11 and 12.

FIG. 11 illustrates a tubular probe sanitizer or sheath 330 for storing a sanitizer solution for use in sanitizing a probe 308. An upper region of the probe sanitizer 330 comprises a squeegee-like material 312 for removing the sanitizer solution from the probe 308 as the probe is withdrawn from the probe sanitizer 330. The squeegee like material 312 also seals the sanitizer solution within the probe sanitizer 330 when the probe 308 is disposed within the sanitizer 330.

The probe sanitizer 330 further comprises a hook or clip 338 for removably attaching the probe sanitizer 330 to an object, such as the enclosure for the device 10, when not in use. The clip 338 is affixed to the tubular probe sanitizer 330 by a material ring 340 that is sprung radially outwardly to affix the clip 388 to the tubular probe sanitizer 330. The material ring then returns to its unbiased configuration and exerts a radially inwardly directed force against an external surface of the probe sanitizer 330. However, it has been determined that the force exerted by the ring 338 on the probe sanitizer 330 may not be sufficient in all situations to retain the clip 388 in position about the probe sanitizer 330. Thus in one embodiment an additional band of elastic material 342 is placed around the clip 338 to provide an additional radially inwardly directed force, which when added to the force exerted by the clip 338 is sufficient to retain the clip in position. This additional force resolves user complaints that the force exerted by the ring 338 is insufficient to hold the probe sanitizer 330 in place when affixed to the object, but also provides a certain amount of elasticity.

The probe sanitizer or sheath 330 is integrated into (e.g., molded into) an enclosure 400 of the device as shown in FIG. 12. The sheath further utilizes a battery compartment door as one surface of the sheath 330. Removal of the battery door exposes inside surfaces of the compartment for easy cleaning and removal of food particles that may have become lodged in the compartment when the probe 308 was inserted into the compartment.

The device further comprises a probe connector 404 and a probe connector compartment 408 for protecting the connector that provides electrical connectivity between a probe cable 410 and the device 10. See FIG. 12. The probe connector compartment 408 provides strain relief for the probe cable 410. The compartment 408 also conceals the cable 410 when the device is not in use.

Another embodiment of the device 10 comprises an apparatus and method for detecting whether the user correctly followed applicable temperature measurement protocols. Or, for example, did the user simply insert the probe 308 into a single food item and use this value of measured temperature as the measured temperature for additional food items. As is known, this methodology is a violation of food temperature measurement standards and must be detected.

To make this determination, the present invention comprises a software and firmware algorithm that continues to monitor and record the probe temperature after the temperature of a first food item has been measured and recorded. This feature is unknown to the user as the device continues to function with no evidence that temperature monitoring continues.

Prior to measuring a temperature of a first food item, the user sets the device to measure food items that are kept at about a similar temperature. For example, all items in the hot food area will have about the same temperature and all items in cold storage will also be at about the same temperature. The user selects from among these and other presented controlled temperature storage and serving locations and then sequentially measures the temperature of each food item in the selected storage/serving location.

Also, after each food item temperature is taken, the food safety protocol requires, that after the probe is removed from the food item, it is wiped down and sanitized by placing in a sanitizing solution. After the probe has been cleaned it is inserted (in one embodiment the device prompts the user to make the second food item temperature measurement) into a second food item and the user commands it to measure the temperature of the second food item. Generally, there will be a temperature profile of the temperatures sensed by the probe after it is removed from the first food item.

If the user had not removed the probe 308 from the first food item, the probe 308 will not sense a temperature change to room temperature, for example, as would be expected after the temperature of the first food item has been taken. Failing to detect that temperature change, the device records this information in a manager/supervisor report. This false measurement “alarm” to management/supervisor personnel indicates that a temperature change was not detected as expected within a given period of time after measuring the first food item temperature. This could indicate that the user did not remove the probe 308 from the first food item prior to measuring the temperature of the second food item. Instead, the user commanded the device to measure the second food item temperature while the probe 308 remained in the first food item. The user is not aware of this “alarm” as it appears only on the report accessed by management/supervisory personnel. The user is also not aware that the probe continues to measure the temperature after the probe has been removed from a food item.

In addition to or in lieu of a simple temperature difference threshold taken at two instants in time, the device 10 can be programmed to determine a temperature change profile, i.e., temperature changes over a determined time interval. Typically this temperature profile should reflect the expected temperatures when the probe is removed from the first food item, wiped down, sanitized and inserted into a second food item, with the temperature of the second food item perhaps similar to the temperature of the first food item. Further, these temperature changes should occur within a predetermined number of seconds. If this profile is not satisfied, within tolerance values for both the time and temperature parameters, then the user did not follow food safety protocols and an “alarm” or notation is recorded in the management/supervisor report.

According to another feature, the device 10 measures the time interval between measuring and recording the first food item temperature and taking the temperature of the second food item and determines whether the measured time interval is less than a reference time interval. Management/supervisory personnel can set the time interval between measurements as desired. 15 seconds is one common interval, allowing time to wipe and sanitize the probe 308. If the successive measurements were taken within less than the predetermined time interval then an insufficient time between temperature measurements notation is recorded. This may be referred as an insufficient time “alarm” and indicates that the user did not wipe down and sanitize the probe or the user left the probe within the first food item when taking the temperature of the second food item. That is, the interval between temperature measurements was too short for the user to have executed the required steps in accordance with the applicable food temperature measurement protocol.

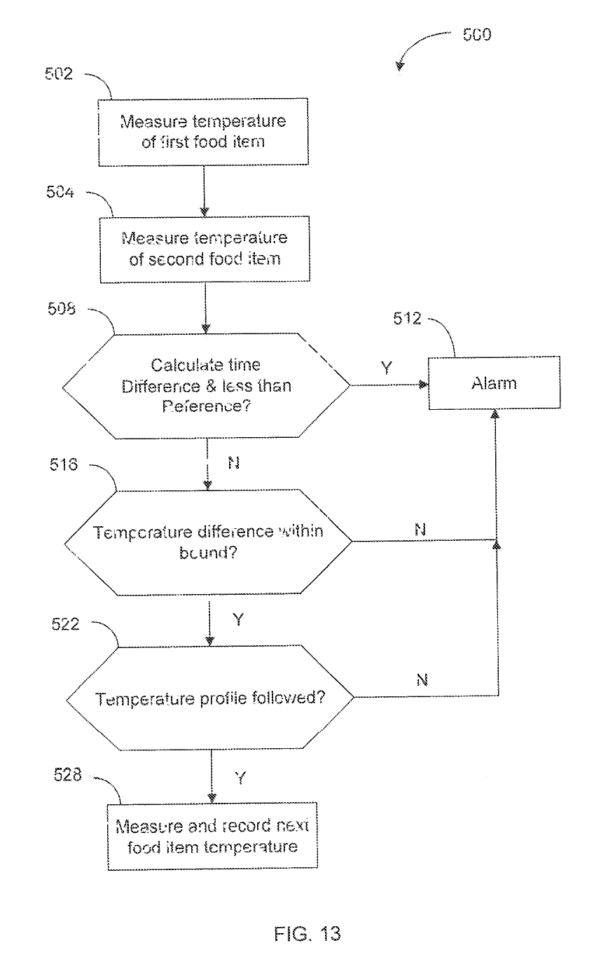

Thus the present invention comprises an algorithm 500 set forth in FIG. 13 for determining whether proper protocol was followed and for setting “alarms” in the management/supervisor report.

The device 10 measures the temperature of a first food item at a step 502 and of a second food item at a step 504. At a decision step 508 the amount of time taken between temperature measurements of the first and a second food items is calculated and it is determined whether this interval is less than the reference interval (e.g., 15 seconds). An affirmative response executes an “alarm” step 512.

A negative response from the decision step 508 continues executing to a decision step 516 to determine whether the difference between the temperature of food items one and two is within a predetermined bound. An affirmative answer suggests that the first and second food items may be within the same temperature-controlled area, e.g., both within the hot food storage area. This response reflects that the user is measuring all the hot food item temperatures, for example, before moving to a different temperature-controlled area. Processing from the affirmative response from the decision step 516 proceeds to a decision step 522.

Alternatively this affirmative response from the decision step 516 may indicate that the user did not remove the probe from the first food item before proceeding to measure the temperature of the second food item and thus generated a false temperature measurement.

A negative response from the decision step 516 proceeds to the alarm step 512 where a notation is made in the management/supervisor report that the proper protocols were not followed.

The decision step 522 inquires whether the determined temperatures (i.e., after the probe was removed from a food item) followed an expected temperature profile. If the measured temperatures followed that profile the result from the decision step 522 is affirmative and the next food item temperature is taken and recorded at a step 528.

If the result from the decision step 522 is negative then the “alarm” notation is made in the management/supervisor report. The “alarm” at the step 512 may also be referred to as a false measurement detection alarm or a insufficient time alarm, depending on the source of the alarm.

Although the “alarms” referred to above suggest a notation in the management/supervisor report, the alarms can also include a local alarm that is provided only at the device 10 with an attendant user lock-out. The device 10 also records details of any “alarm” event, including the time of occurrence and the name of the user at that time. This same information is sent to a reporting station where all the temperature information is stored. Also, it is not necessary to include all the decision steps set forth in the algorithm 500 in any one embodiment.

While the invention has been described with reference to preferred embodiments, it will be understood by those skilled in the art that various changes may be made and equivalent elements may be substituted for elements thereof without departing from the scope of the invention. The scope of the present invention further includes any combination of the elements from the various embodiments set forth herein. In addition, modifications may be made to adapt a particular situation to the teachings of the present invention without departing from its essential scope.

What is claimed is:

1. A method for determining false food temperature measurements using a food temperature measuring device, the method comprising:
(a) measuring a first temperature of a first food item using a temperature probe;
(b) commanding a second temperature measurement to be performed;
(c) determining a time interval between execution of steps(a) and (b); and
(d) indicating a false temperature measurement responsive to step (c).

2. The method of claim 1 wherein the step of indicating comprises adding a false temperature measurement remark to a temperature measurement report available only to management/supervisor personnel of a user operating the food temperature measuring device.

3. The method of claim 1 wherein the step of indicating comprises activating a local alarm at the food temperature measuring device and locking out the food temperature measuring device from further use.

4. The method of claim 1 wherein step (d) is executed when the time interval is shorter than a reference time interval.

5. The method of claim 4 wherein the reference time interval comprises 15 seconds.

6. The method of claim 1 further comprising a step (a1) removing the probe from the first food item and continuing to measure subsequent temperatures, further comprising determining whether the subsequent temperatures match an expected temperature profile, and if the subsequent temperatures do not match the expected temperature profile executing step (d).

7. The method of claim 6 wherein the expected temperature profile comprises a first segment related to a temperature of the probe in an ambient environment and a second segment related to a temperature of a sanitizing solution.

8. The method of claim 1 further comprising measuring a temperature of a second food item and determining whether a difference between the first temperature and the temperatures of the second food item is within a reference temperature range.

9. A method for determining false food temperature measurements, the method comprising:
(a) measuring a temperature of a first food item using a temperature probe;
(b) automatically measuring additional temperatures after executing step (a);
(c) comparing the additional temperatures measured at step (b) with an expected temperature profile; and
(d) indicating a false temperature measurement responsive to step (c).

10. The method of claim 9 wherein step (b) is executed without user intervention.

11. The method of claim 9 wherein step (d) is executed if differences between the additional temperatures and the expected temperature profile exceed predetermined differences.

12. The method of claim 9 wherein the expected temperature profile comprises a first segment related to a temperature of the probe in an ambient environment and a second segment related to a temperature of a sanitizing solution.

13. A method for determining false temperature measurements by a user operating a food temperature measuring and recording device, the method comprising:
(a) measuring a temperature of a first food item using a temperature probe;
(b) storing the temperature of the first food item;
(c) without user intervention, measuring additional temperatures after executing step (a);
(d) comparing the additional temperatures measured at step (c) with an expected temperature profile; and
(d) indicating a false temperature measurement if the additional temperatures do not substantially match the temperature profile.

14. The method of claim 13 wherein the expected temperature profile comprises a first segment related to a temperature of the probe in an ambient environment and a second segment related to a temperature of a sanitizing solution.
